(19) United States
(12) Patent Application Publication
(10) Pub. No.: US 2015/0215476 A1
(43) Pub. Date: Jul. 30, 2015

(54) Electronic Device

(71) Applicants: Sintai Optical (Shenzhen) Co., Ltd., Shenzhen City (CN); Asia Optical International Ltd., Tortola (GB)

(72) Inventors: Hsien-Chi Lin, Taichung (TW); Ming-Fu Hsu, Taichung (TW); Chih-Wen Wang, Taichung (TW)

(21) Appl. No.: 14/601,286

(22) Filed: Jan. 21, 2015

(30) Foreign Application Priority Data
Jan. 24, 2014 (TW) 103102598

(51) Int. Cl. H04N 1/00; H04N 1/21

(52) U.S. Cl. CPC H04N 1/0044; H04N 1/2108; H04N 1/0049

(57) ABSTRACT

An electronic device of the invention includes a pick-up module configured to pick up an image of a scanned object to generate an initial data; a processing unit configured to convert the initial data into an image data; and a projection module configured to convert the image data into an optical image and project the optical image.

### BACKGROUND OF THE INVENTION

1. Field of the Invention

The invention relates to an electronic device, and more particularly to an electronic device capable of scanning and projecting operations.

2. Description of the Related Art

Recently, compact electronic devices with multi-functions have become a main trend in electronic product market, and this is also what consumers expect.

Conventional scanners have good scan effect, but it is not convenient for carriage because they occupy a considerable space. Conventional portable scanners are not equipped with large LCD due to the requirements of light weight and low price, and thus scanned images generated by the conventional portable scanners cannot be shown by a computer immediately. Furthermore, if the scanning process of the portable scanner is disturbed, the scanned image may be not qualified. Since a user cannot view the scanned image immediately, he cannot determine whether the scanned image is qualified and can be saved or he must do the scanning again. It is not convenient for users.

### BRIEF SUMMARY OF THE INVENTION

The invention provides an electronic device capable of projecting an image caught by the electronic device for a user viewing the image and determining whether the image is qualified. Thus no display device is needed, which reduces cost and volume of the electronic device. It is convenient for carriage and thus easily acceptable for market.

The invention provides an electronic device. The electronic device in accordance with an exemplary embodiment of the invention includes a pick-up module configured to pick up an image of a scanned object to generate an initial data; a processing unit configured to convert the initial data into an image data; and a projection module configured to convert the image data into an optical image and project the optical image.

The electronic device in accordance with another exemplary embodiment of the invention includes a processing unit configured to receive an initial data and convert the initial data into an image data; and a projection module configured to convert the image data into an optical image and project the optical image.

In another exemplary embodiment, a register unit in which the initial data is stored.

In yet another exemplary embodiment, a storage unit in which the image data is stored

In another exemplary embodiment, the image data is an electronic data in a projection format.

In yet another exemplary embodiment, the projection module is a pico projector.

In another exemplary embodiment, a control button is configured to electrically connect to the processing unit.

In yet another exemplary embodiment, a connecting port is configured to connect to an external electronic equipment via a cable.

In another exemplary embodiment, a connecting port is configured to connect to an external electronic equipment wirelessly.

In yet another exemplary embodiment, the pick-up module includes a light source and a photo-electronic converting unit. The light source is configured to emit a light beam. The light beam is reflected by the scanned object and received by the photo-electronic converting unit. The reflected light beam is converted into electronic signals to form the initial data.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of an embodiment of an electronic device of the invention;

FIG. 2 is a schematic view of an embodiment of an electronic device of the invention;

FIG. 3 is a flow chart of an embodiment of a scanning-projecting method of the invention; and

FIG. 4 is a flow chart of an embodiment of a projecting method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

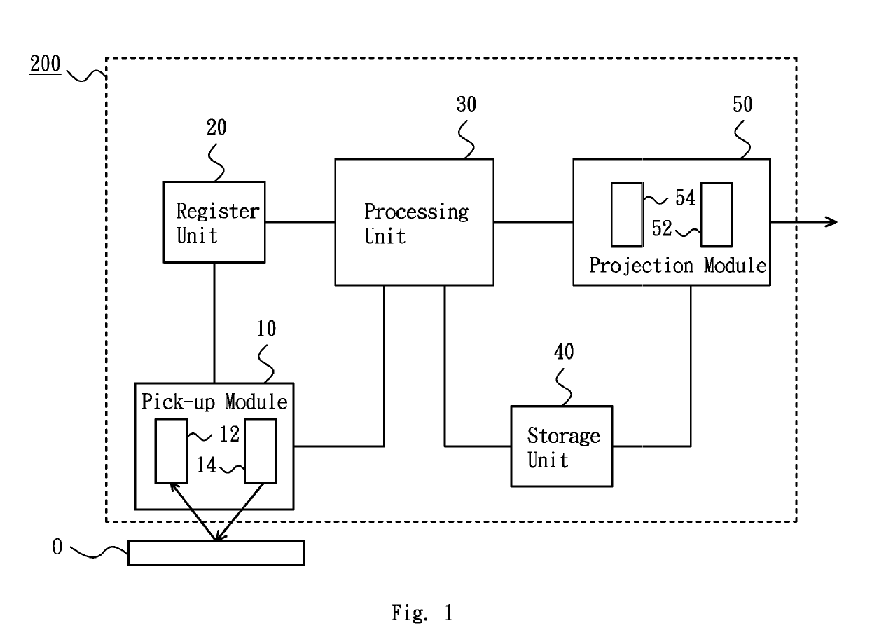

Referring to FIG. 1, an electronic device 200 includes a pick-up module 10, a register unit 20, a processing unit 30, a storage unit 40 and a projection module 50.

The pick-up module 10 detects a scanned object O and scans the scanned object O to generate an initial data. In an embodiment, the pick-up module 10 includes a photo-electronic converting unit 12 and a light source 14. The light source 14 emits light to the scanned object O, and the light is reflected by the scanned object O and received by the photo-electronic converting unit 12. The received light is converted by the photo-electronic converting unit 12 into the initial data. The initial data can be a text data or a still image. The photo-electronic converting unit 12 can be a charged coupled device (CCD) or complementary metal-oxide semiconductor (CMOS), but is not limited thereto.

The register 20 is electrically connected to the pick-up module 10. When the pick-up module 10 generates the initial data, the initial data can be stored in the register unit 20. In an embodiment, the register unit 20 includes at least one random access memory (RAM). The random access memory includes dynamic random access memory (DRAM) and static random access memory (SRAM), but is not limited thereto.

The processing unit 30 is electrically connected to the pick-up module 10 and register unit 20. When the processing unit 30 receives the initial data from the pick-up module 10 or the register unit 20. The processing unit 30 converts the initial data into an image data. In an embodiment, the image data is an electronic data in a projection format. The processing unit 30 can be an integrated circuit, a circuit module or a firmware.

The storage unit 40 is electrically connected to the processing unit 30. When the processing unit 30 converts the initial data into an image data, the image data is transferred to the storage unit 40 and stored therein. The storage unit 40 can be built in the electronic device 200, such as a hard disc or memory; or the storage unit 40 is removably connected to the electronic device 200, such as a memory card or a flash disc, but it is not limited thereto.

The projection module 50 is electrically connected to the processing unit 30 and the storage unit 40. The projection module 50 receives the image data from the processing unit 30 or the storage unit 40, converts the image data into optical image of the scanned object O and projects the optical image from the electronic device 200. The projection module 50 can be a pico projector. In an embodiment, the projection module 50 includes a projecting lens 52 and an image generating unit 54. The image generating unit 54 includes a filtering sheet, a prism and/or a digital light processor.

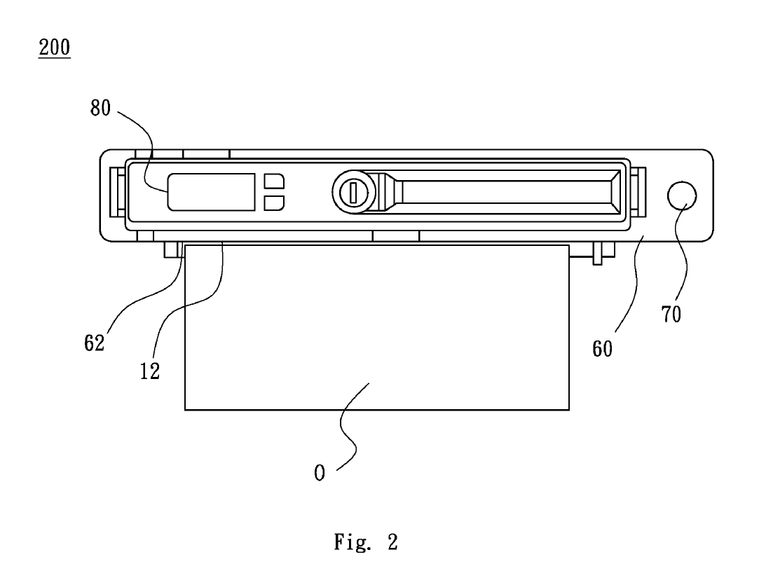

FIG. 2 shows an embodiment of an electronic device of the invention.

Referring to FIGS. 1 and 2, the electronic device 200 includes a housing 60, a control button 70 and a connecting port 80. The housing 60 has an opening 62.

In an embodiment, the photo-electronic converting unit 12 of the pick-up module 10 is exposed through the opening 62 so that the light reflected by the scanned object O is received by the photo-electronic converting unit 12 for photo-electrical conversion to generate the initial data.

The control button 70 is disposed on the housing 60 and electrically connected to the processing unit 30. A user can push the control button 70 to enable the electronic device 200 to scan or project.

In an embodiment, the connecting port 80 is disposed on the housing 60. When the user connects an external electronic device to the electronic device 200 through a cable (not shown) connected to the connecting port 80, image data from the external electronic device is transmitted to the storage unit 40 or the processing unit 30 and converted into corresponding optical images by the projection module 50. The optical images are projected from the electronic device 200.

In another embodiment, the connecting port 80 is built in the electronic device 200. The user connects the external electronic device to the electronic device 200 wirelessly, whereby the image data from the external electronic device is transmitted to the storage unit 40 or the processing unit 30 and converted into corresponding optical images by the projection module 50. The optical images are projected from the electronic device 200. The external electronic device can be a personal computer, a laptop or a handheld device, such as a hand phone, a camera or a tablet, but it is not limited thereto.

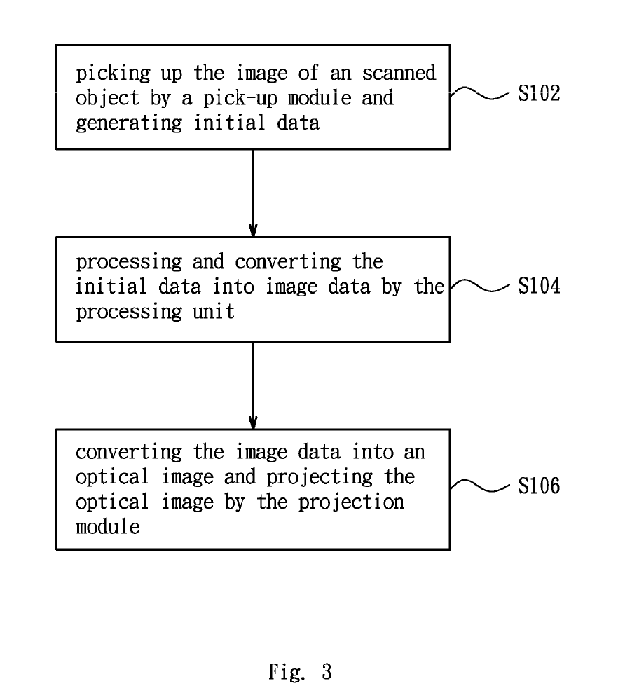

FIG. 3 is a flow chart of an embodiment of a scanning and projecting method of the invention.

Referring to FIGS. 1 and 3, when the processing unit 30 receives a scanning command from a user, step S102 is performed. In step S102, the electronic device 200 scans a scanned object O through a pick-up module 10 to generate an initial data. The initial data can be a text data or a still image.

Afterwards, step S104 is performed. In the step S104, the processing unit 30 processes the initial data and converts the initial data into the image data.

Finally, the processing unit 30 performs step S106. In the step S106, the projection module 50 converts the image data into optical images of the scanned object O. The optical images are projected from the electronic device 200.

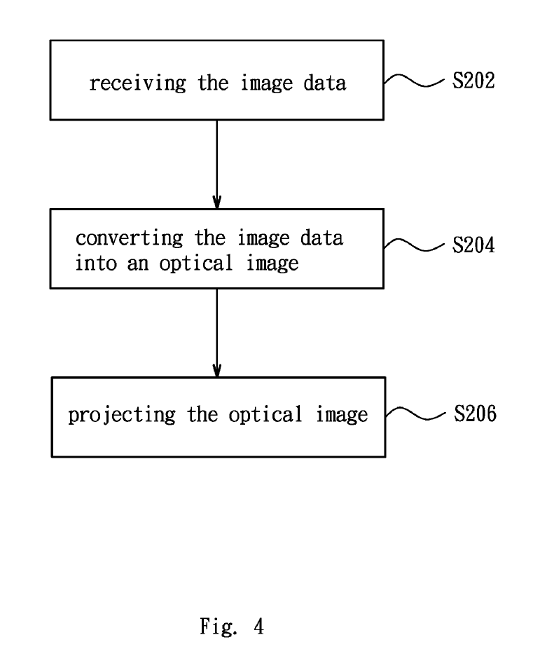

FIG. 4 is a flow chart of an embodiment of a projecting method of the invention.

Referring to FIGS. 1 and 4, when the electronic device 200 receives a scanning command from the user or electrically connects to an external electronic device through the connecting port 80, step S202 is performed. In the step S202, the image data are received from the external electronic device, wherein the image data can be electronic data in a projection format.

Afterwards, step S204 is performed. In the step S204, the image data are converted into optical images.

Finally, the electronic device 200 performs step S206 according to commands from a user. In the step S206, the optical images are projected from the electronic device 200.

As shown in FIGS. 1 to 4, the electronic device 200, the projecting method and the scanning-projecting method projects scanned images for a user viewing the scanned image and determining whether the scanned image is qualified. No display device is needed. Thus cost of the electronic device 200 is reduced, and the electronic device 200 occupies a smaller space and is suitable for carriage.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a pick-up module configured to pick up an image of a scanned object to generate an initial data;
a processing unit configured to convert the initial data into an image data; and
a projection module configured to convert the image data into an optical image and projecting the optical image.

2. The electronic device as claimed in claim 1 further comprising a register unit configured to store the initial data.

3. The electronic device as claimed in claim 1 further comprising a storage unit configured to store the image data.

4. The electronic device as claimed in claim 1, wherein the image data is an electronic data in a projection format.

5. The electronic device as claimed in claim 1, wherein the projection module is a pico projector.

6. The electronic device as claimed in claim 1 further comprising a control button configured to electrically connect to the processing unit.

7. The electronic device as claimed in claim 1 further comprising a connecting port configured to connect to an external electronic equipment via a cable.

8. The electronic device as claimed in claim 1 further comprising a connecting port configured to connect to an external electronic equipment wirelessly.

9. The electronic device as claimed in claim 1, wherein the pick-up module comprises a light source and a photo-electronic converting unit, the light source is configured to emit a light beam, the light beam is reflected by the scanned object and received by the photo-electronic converting unit, and the reflected light beam is converted into electronic signals to form the initial data.

10. An electronic device, comprising:
a processing unit configured to receive an initial data and convert the initial data into an image data; and
a projection module configured to convert the image data into an optical image and project the optical image.

11. The electronic device as claimed in claim 10 further comprising a register unit configured to store the initial data.

12. The electronic device as claimed in claim 10 further comprising a storage unit configured to store the image data.

13. The electronic device as claimed in claim 10, wherein the image data is an electronic data in a projection format.

14. The electronic device as claimed in claim 10, wherein the projection module is a pico projector.

15. The electronic device as claimed in claim 10 further comprising a control button configured to electrically connect to the processing unit.

16. The electronic device as claimed in claim 10 further comprising a connecting port configured to connect to an external electronic equipment via a cable.

17. The electronic device as claimed in claim 10 further comprising a connecting port configured to connect to an external electronic equipment wirelessly.
